(19) United States
(12) Patent Application Publication
(10) Pub. No.: US 2025/0262929 A1
(43) Pub. Date: Aug. 21, 2025

(54) SENSORED CYCLOIDAL DRIVE UNIT GEARBOX CONTAINING INTEGRATED MOTOR AND CONTROL SCHEME

(71) Applicant: ConcisionAg LLC, Brook, IN (US)

(72) Inventors: Kyler Laird, Rensselaer, IN (US); Kai Justice, Wheatfield, IN (US); Trenton Rhodes, Michigan City, IN (US)

(73) Assignee: ConcisionAg LLC, Brook, IN (US)

(21) Appl. No.: 19/054,892

(22) Filed: Feb. 16, 2025

Related U.S. Application Data
(60) Provisional application No. 63/554,663, filed on Feb. 16, 2024.

(51) Int. Cl. B60K 17/04; B60K 7/00; B60L 3/00; B60L 15/00; B60L 15/20; F16H 57/02; F16H 57/04

(52) U.S. Cl. CPC B60K 17/046; B60K 7/0007; B60L 3/0061; B60L 15/007; B60L 15/20; F16H 57/02; F16H 57/0486; B60K 2007/0092; B60L 2240/425; F16H 2057/02026; F16H 2057/02034; F16H 2057/02052; F16H 57/0402; F16H 57/0405

(57) ABSTRACT

A drive unit has an integrated modular design that is generally able to operate in a self-sufficient manner or independently from other agricultural equipment such as agricultural vehicles. The drive unit includes an electric motor, a cycloidal gear train powered by the electric motor, and a controller that controls the drive unit and monitors the health of the drive unit. The cycloidal gear train is able to efficiently convert the high output speed of the electric motor into a high torque output. Due to the compact design of the cycloidal gear train, the drive unit can be incorporated into a wide variety of agricultural equipment.

### CROSS REFERENCE TO RELATED APPLICATIONS

This application claims the benefit of U.S. Patent Application No. 63/554,663, filed Feb. 16, 2024, which is hereby incorporated by reference.

### BACKGROUND

Modern farming requires a wide variety of powered agricultural equipment. For instance, tractors, grain carts, irrigation, high clearance sprayers, and tracked plow vehicles are now commonly used on farms. However, the purchase, maintenance, and energy costs for operating such equipment can be quite expensive. Agricultural equipment manufacturers are also making the equipment more difficult for farmers to repair, replace, and modify to suit the individual needs of the farmers.

Thus, there is a need for improvement in this field.

### SUMMARY

A unique drive unit has been developed to address the above-mentioned as well as other issues. The drive unit has an integrated modular design that is generally able to operate in a self-sufficient manner or independently from other agricultural equipment such as agricultural vehicles. The drive unit includes an electric motor, a cycloidal gear train powered by the electric motor, and a controller that controls the drive unit and monitors the health of the drive unit. The cycloidal gear train is able to efficiently convert the high output speed of the electric motor into a high torque output. Due to the compact design of the cycloidal gear train, the drive unit can be incorporated into a wide variety of agricultural equipment. In one use case example, the drive unit is incorporated into a wheel assembly of an agricultural vehicle like a tractor. It was discovered that the high torque and precise control of the cycloidal gear train was well suited for agricultural applications such as for tractors or other agricultural equipment. The drive unit is further self-contained in that the drive unit also includes stand-alone lubrication and cooling subsystems. In one form, lubricant inside the drive unit is used to lubricate the cycloidal gear train as well as to cool the electric motor. All of the lubricant used for lubrication and cooling of the drive unit is self-contained and circulated within the drive unit. In other words, the drive unit able to cool and lubricate the components of the drive unit without receiving lubricant or other cooling fluids from external sources. Without this need for external lubricant and/or coolant lines, a farmer can readily swap the modular drive units.

Having the controller incorporated into the drive unit further facilitates the modular or independent capabilities of the drive unit. Through sensors located throughout the drive unit, the controller is able to monitor the health of the drive unit and take appropriate corrective actions. Rather than experiencing the daunting process of hacking into a copyright protected controller in the agricultural equipment, a farmer or repair person can directly plug into and access the controller of the drive unit so as to easily receive data, such as error codes, and take corrective actions. If the farmer finds a broken drive unit difficult to repair, the farmer can flash the control software and/or firmware from the broken drive unit into the controller of the replacement drive unit. The broken drive unit can then be physically swapped out for the replacement drive unit with little interruption to the operation of the equipment. The decentralized nature of the drive unit further facilitates the farmer or others to experiment and make quick changes to the operation of the drive unit to suit the particular needs of the situation. For instance, the farmer can connect to the controller via a wired or wireless connection so as to reprogram the operation of the drive unit. The drive unit is further configured to communicate with external equipment and even other drive units. The modular nature of the drive unit further allows the drive units to be mechanically and/or electronically connected together to operate in a coordinated fashion.

During development of the drive unit, it was recognized that conventional agricultural equipment including, but not limited to, tractors, grain carts, irrigation, high clearance sprayers, and tracked plow vehicles, typically use internal combustion engine (ICE) powered hydraulic drive trains or electric powered hydraulics. Although effective, it has been found that these hydraulic systems are not energy efficient, require a myriad of maintenance activities, and have limitations in precision of movement control. As compared to these conventional systems, electrically powered vehicles and equipment have better efficiency, speed, data collection, accuracy, and yield. Fully electric mobile power systems have been developed to provide more power with higher precision and faster reaction times. With the electric motor, the drive unit is able to provide these electric powered capabilities to a wide variety of equipment.

In one aspect, the drive unit is used for vehicular applications or other types of applications. The drive unit includes a motor, a cycloidal gearbox or gear train, a sensor subsystem, a power inverter, and a logic device like a processor. The motor is configured to provide motive power. The cycloidal gearbox is coupled to the motor for high torque transmission and efficient speed reduction. The sensor subsystem includes at least one temperature sensor for monitoring operational parameters of the drive unit. The motor power inverter is configured to commutate the motor. The logic device is configured to process operational data from the sensor subsystem and adjust motor operation accordingly. The drive unit further includes an oil handling subsystem for lubrication and cooling of the drive unit components. A cooling subsystem can be used to cool the drive unit. For example, the cooling subsystem can include a liquid cooling, air cooling, and/or refrigerant cooling system for maintaining operational temperatures of the drive unit. The drive unit in one form includes a hub for housing the components of the drive unit and connecting the drive unit to external components.

The drive unit in some variations includes mounting provisions for attaching external sensors, brackets, and auxiliary components to enhance adaptability to different operational requirements. The motor controller in one form is integrated within the drive unit and is equipped with a logic circuit and an inverter circuit capable of accommodating at least one signal input. In some cases, the drive unit is equipped with external connection features, such as an adapter, for attachment to various hubs, facilitating compatibility with rims of different diameters. The drive unit can include a gearbox oil or lubrication subsystem designed to ensure lubrication reaches all or most of the parts of the drive unit that need lubrication. In some variations, the dive unit includes a magnet for attracting and collecting ferrous materials. The drive unit in select variations features a comprehensive sensor subsystem designed for health monitoring of the drive unit via sensors in the gearbox and motor. The sensor subsystem is capable of tracking oil level, oil temperature, motor winding temperature, and/or motor speed. The sensor subsystem allows for the calculation of oil life, coolant life, bearing life, and/or failure mode detection. The drive unit serves a dual function as both load-bearing and as the hub by incorporating load-bearing roller bearings designed for heavy-duty applications. An axle or shaft of the drive unit may be either solid or hollow. When the axle is hollow, the axle allows for the internal routing of cables, oil, and coolant to enhance the versatility of the drive unit and integration capabilities. The drive unit is capable of functioning as the driving force behind a variety of non-vehicular devices, including winching, slewing, and the articulation of manipulator joints. The drive unit adaptable across a broad spectrum of applications.

Another aspect concerns a method of operating the vehicular drive unit. During operation, the motor drives the cycloidal gearbox to achieve high torque transmission. The sensor subsystem monitors operational parameters. The sensor subsystem includes at least one temperature sensor. The motor is commuted with a motor power inverter. The operational data is processed with a logic device to adjust motor operation. The components of the drive unit are lubricated and cooled with an oil handling system. maintaining optimal operational temperatures with a cooling system chosen from liquid cooling, air cooling, and refrigerant cooling. A further features concerns a communication method to external system components. The communication method is capable of publishing and subscribing data and commands.

Still yet a further aspect concerns a health monitoring system for the drive unit in vehicular applications. The system includes a plurality of sensors configured to monitor operational parameters of the drive unit. These sensors can include at least one temperature sensor to measure the temperature of motor windings and lubricating oil, a speed sensor to monitor the rotational speed of the drive unit, and an oil level sensor to determine the lubricant quantity within the drive unit. A logic device is configured to receive and process data from the sensors. The logic device is programmed to calculate health metrics of the drive unit based on the monitored operational parameters or raw data. The health metrics for example include oil life, coolant life, bearing life, and detection of failure modes. A data storage module, such as memory, is coupled to the logic device. The data storage module is configured to store historical operational data and health metrics for trend analysis over time. A communication interface is integrated with the logic device. The communication interface is designed to transmit alerts and health reports to an external maintenance system for preventive maintenance scheduling based on the trend analysis and calculated health metrics. The system further includes one or more gyroscopes and accelerometers to detect changes in mechanical frequencies and vibrations. This enables the logic device to identify deviations in the operational parameters indicative of potential maintenance needs or system failures of the drive unit. The health monitoring system utilizes real-time and historical data analysis to provide predictive maintenance alerts to enhance operational efficiency and longevity of the drive unit by preemptively identifying and addressing potential issues before system failure occurs. In some cases, the drive unit may include provisions to interact with a tire. For example, the drive unit may increase or decrease air pressure in the tire to enhance tire traction. The drive unit is further capable of circulating fluid in the tire such as cooling fluid for the motor and gearbox.

This system generally relates to using the drive unit where high torque and short axial length are preferable and lends itself to a high gear ratio. A unique sensored cycloidal drive unit gearbox containing integrated motor and control has been developed. Hybrid equipment, such as equipment that is arranged to receive power from an electric battery source and an internal combustion engine, and convert the output to electrical energy to be utilized by the drive functions, bear similar desirable features surrounding performance enhancements such as efficiency, speed, data collection, and accuracy. One drawback of electric motors compared to hydraulic motors is their inherent need to operate at relatively high speeds to maintain efficiency within their desired operational range. In contrast, hydraulic motors can typically function at lower speeds. The hydraulic circuit also aids in dissipating additional heat, contributing to enhanced heat dissipation and efficiency in hydraulic systems.

Hydraulic drive units commonly employ planetary gearboxes in situations where gear reductions are necessary. Planetary gearboxes are generally suitable for applications where precision in positioning and avoidance of lost motion are not critical concerns. Planetary gear systems are best suited for single stage reductions of 5:1 or lower. Planetary gear systems have more parts than cycloidal drive systems. The additional parts lend themselves to additional failure points. A cycloidal gear system stands out as a specialized drive gearbox, renowned for its ability to transmit large torque loads efficiently through a single-stage mechanism, offering higher gear ratios compared to planetary systems in a more compact form. This type of gear system is particularly advantageous in applications that demand exceptional positional accuracy and minimal backlash. The high gear ratio characteristic of cycloidal gear systems allows electric motors to function within their optimal efficiency ranges, enhancing overall performance.

The drive units are suitable for vehicular application requiring high torque, high power, low speed applications. The drive unit includes several subsystems that include a motor configured to drive the cycloidal gearbox, a sensor system to monitor drive unit systems that includes at least one temperature sensor, a motor power inverter used to commutate the motor, a logic device, and an oil handling subsystem.

The system generally relates to an advanced drive unit specifically designed for vehicular applications that demand high torque and power at low speeds, with a particular focus on achieving high gear ratios within a compact axial length. The system addresses the inefficiencies and maintenance challenges of conventional hydraulic systems found in agricultural equipment like tractors and sprayers. This system introduces a unique approach that combines the benefits of electric and hybrid power sources. The system integrates a cycloidal gearbox. The cycloidal gearbox or gear train enhances torque transmission and efficiency while in a compact form factor. It was found that the cycloidal gear train was well suited for traction and other applications requiring precise positional accuracy and minimal backlash.

Once more, the drive unit is a comprehensive system. The drive unit encompasses a motor, a sensor subsystem for temperature monitoring, a power inverter for motor commutation, a logic device for operational adjustments, and an oil handling system for component lubrication and cooling. Enhanced by a tuned motor controller, the unit enhances operational efficiency and torque maximization across various duty cycles and cooling requirements. The design includes provisions for mounting external sensors and auxiliary components, adapting to diverse vehicular and non-vehicular applications

A health monitoring system, employs a suite of sensors for real-time tracking of parameters like oil and motor winding temperatures, and speed. This system enables predictive maintenance, extending the operational lifespan of the drive unit by preemptively identifying potential failures. The design of the drive unit may accommodate solid or hollow shafts, catering to a wide range of mechanical configurations and cooling strategies, from liquid to refrigerant cooling. The drive unit provides versatile, efficient capabilities for heavy-duty applications, showcasing adaptability not only across different vehicular platforms but also in non-vehicular devices requiring precise control and movement. This drive unit provides operational efficiency for a wide array of applications.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including equipment.

Aspect 3 generally concerns the system of any previous aspect in which the equipment is agricultural equipment.

Aspect 4 generally concerns the system of any previous aspect including a vehicle.

Aspect 5 generally concerns the system of any previous aspect including a wheel assembly.

Aspect 6 generally concerns the system of any previous aspect including a bracket.

Aspect 7 generally concerns the system of any previous aspect in which the bracket is coupled to the vehicle.

Aspect 8 generally concerns the system of any previous aspect including a wheel.

Aspect 9 generally concerns the system of any previous aspect in which the wheel assembly includes the wheel.

Aspect 10 generally concerns the system of any previous aspect including a drive unit.

Aspect 11 generally concerns the system of any previous aspect including a motor.

Aspect 12 generally concerns the system of any previous aspect in which the motor is configured to provide motive power.

Aspect 13 generally concerns the system of any previous aspect including an axle.

Aspect 14 generally concerns the system of any previous aspect in which the bracket has the axle.

Aspect 15 generally concerns the system of any previous aspect including an electric motor.

Aspect 16 generally concerns the system of any previous aspect including a cycloidal gear train.

Aspect 17 generally concerns the system of any previous aspect in which the cycloidal gearbox coupled to the motor for high torque transmission and efficient speed reduction.

Aspect 18 generally concerns the system of any previous aspect in which the cycloidal gear train is coupled to the electric motor.

Aspect 19 generally concerns the system of any previous aspect including a controller.

Aspect 20 generally concerns the system of any previous aspect in which the controller is operatively coupled to the electric motor to control the electric motor.

Aspect 21 generally concerns the system of any previous aspect including a housing.

Aspect 22 generally concerns the system of any previous aspect in which the drive unit has the housing.

Aspect 23 generally concerns the system of any previous aspect in which the controller is disposed inside the housing.

Aspect 24 generally concerns the system of any previous aspect in which the controller is secured to the outside of the housing.

Aspect 25 generally concerns the system of any previous aspect including a sensor disposed in the drive unit to monitor at least one property of the drive unit.

Aspect 26 generally concerns the system of any previous aspect in which the sensor is operatively coupled to the controller.

Aspect 27 generally concerns the system of any previous aspect in which the sensor includes a temperature sensor.

Aspect 28 generally concerns the system of any previous aspect in which the housing contains a lubricant.

Aspect 29 generally concerns the system of any previous aspect in which the lubricant is configured to cool the electric motor.

Aspect 30 generally concerns the system of any previous aspect in which the lubricant is configured to lubricate the cycloidal gear train.

Aspect 31 generally concerns the system of any previous aspect in which the temperature sensor is configured to measure temperature of lubricant in the drive unit.

Aspect 32 generally concerns the system of any previous aspect in which the temperature sensor is configured to measure temperature of the electric motor.

Aspect 33 generally concerns the system of any previous aspect in which the temperature sensor is configured to measure temperature of the controller.

Aspect 34 generally concerns the system of any previous aspect in which the sensor includes a resolver configured to monitor the electric motor.

Aspect 35 generally concerns the system of any previous aspect in which the controller is configured to monitor health of the drive unit via the sensor.

Aspect 36 generally concerns the system of any previous aspect in which the sensor includes an inertial measurement unit (IMU).

Aspect 37 generally concerns the system of any previous aspect in which the sensor is a lubricant level sensor that measures a level of the lubricant in the housing.

Aspect 38 generally concerns the system of any previous aspect including a magnet disposed in the housing to collect ferrous materials.

Aspect 39 generally concerns the system of any previous aspect including a lubricant opening defined in the housing.

Aspect 40 generally concerns the system of any previous aspect including a plug configured to plug the lubricant opening.

Aspect 41 generally concerns the system of any previous aspect in which the plug has the magnet.

Aspect 42 generally concerns the system of any previous aspect in which the housing has an air vent.

Aspect 43 generally concerns the system of any previous aspect including a socket extending through the housing.

Aspect 44 generally concerns the system of any previous aspect in which the socket includes a controller socket.

Aspect 45 generally concerns the system of any previous aspect in which the socket is configured to connect to an external power supply to supply electrical power to the drive unit.

Aspect 46 generally concerns the system of any previous aspect in which the socket is configured to connect to an external communication bus.

Aspect 47 generally concerns the system of any previous aspect including an inverter electrically connected to the electric motor.

Aspect 48 generally concerns the system of any previous aspect in which the inverter is disposed inside the drive unit.

Aspect 49 generally concerns the system of any previous aspect in which the axle is hollow.

Aspect 50 generally concerns the system of any previous aspect in which the drive unit has an auxiliary adapter.

Aspect 51 generally concerns the system of any previous aspect in which the auxiliary adapter is configured to secure an auxiliary device to the drive unit.

Aspect 52 generally concerns the system of any previous aspect in which the auxiliary device includes a second drive unit.

Aspect 53 generally concerns the system of any previous aspect in which the axle extends through the drive unit.

Aspect 54 generally concerns the system of any previous aspect in which the axle and the auxiliary adapter define a passage through the drive unit.

Aspect 55 generally concerns the system of any previous aspect in which the drive unit is configured to drive a wheel of a vehicle.

Aspect 56 generally concerns the system of any previous aspect in which the cycloidal gear train includes a ring gear and one or more wave plates engaged in the ring gear.

Aspect 57 generally concerns the system of any previous aspect in which the ring gear is integrated in the housing.

Aspect 58 generally concerns the system of any previous aspect in which the cycloidal gear train includes a yolk engaged to the wave plates.

Aspect 59 generally concerns the system of any previous aspect in which the yolk is integrated in a load plate.

Aspect 60 generally concerns the system of any previous aspect in which the housing and the load plate are configured to rotate in opposite directions when the motor rotates the housing.

Aspect 61 generally concerns the system of any previous aspect in which the load plate is configured to drive a wheel of a vehicle.

Aspect 62 generally concerns a method.

Aspect 63 generally concerns the method of any previous aspect including driving a cycloidal gear train of a drive unit with an electric motor.

Aspect 64 generally concerns the method of any previous aspect including monitoring with a processor one or more properties of the drive unit via one or more sensors.

Aspect 65 generally concerns the method of any previous aspect including controlling operation of the electric motor with the processor based on the properties of the drive unit.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a block diagram of a system that includes a vehicle with one or more wheel assemblies.

FIG. 2 is a perspective view of the FIG. 1 wheel assembly that includes a bracket and a wheel.

FIG. 3 is a front view of the FIG. 1 wheel assembly.

FIG. 4 is a perspective view of the FIG. 1 wheel assembly with the wheel removed.

FIG. 5 is a rear perspective view of the FIG. 1 wheel assembly showing a drive unit that powers the vehicle.

FIG. 6 is a perspective view of the FIG. 1 wheel assembly with the drive unit.

FIG. 7 is a rear perspective view of the FIG. 1 wheel assembly with the wheel removed.

FIG. 8 is a block diagram of the FIG. 1 wheel assembly with the drive unit.

FIG. 9 is an exploded perspective view of the FIG. 5 drive unit.

FIG. 10 is a side perspective view of the FIG. 5 drive unit.

FIG. 11 is an exploded perspective view of the FIG. 5 drive unit around the motor of the drive unit.

FIG. 12 is a cross-sectional view of the FIG. 1 wheel assembly.

FIG. 13 is an exploded perspective view of the FIG. 5 drive unit around the cycloidal gear train of the drive unit.

FIG. 14 is an enlarged cross-sectional view of the FIG. 5 drive unit.

FIG. 15 is a rear enlarged cross-sectional view of the FIG. 5 drive unit.

FIG. 16 is a cross-sectional view of the FIG. 1 wheel assembly with an auxiliary device.

FIG. 17 is an enlarged cross-sectional view of the FIG. 1 wheel assembly with the auxiliary device.

FIG. 18 is a cross-sectional perspective view of the FIG. 5 drive unit.

FIG. 19 is a front view of the FIG. 1 wheel assembly with the load plate removed.

FIG. 20 is a perspective view of the wheel assembly shown in FIG. 19.

FIG. 21 is a block diagram of the FIG. 5 drive unit.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

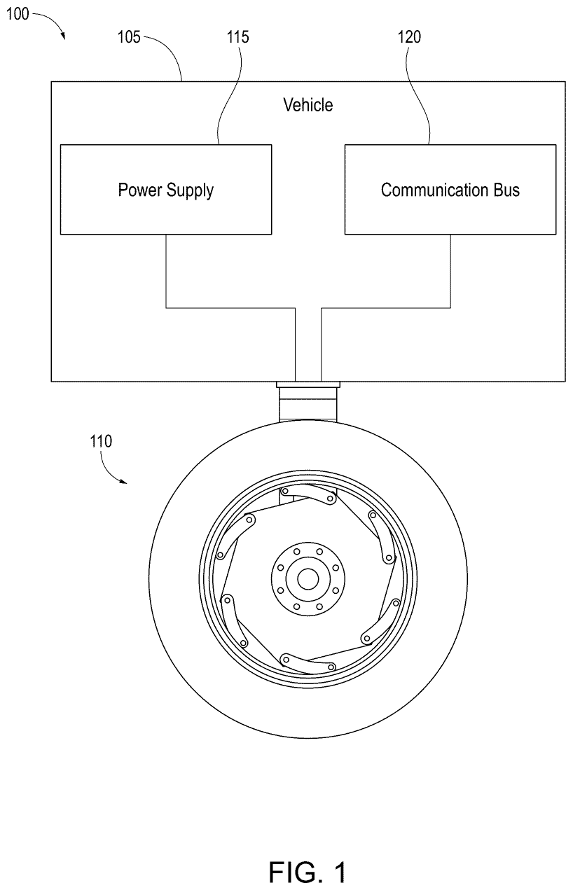

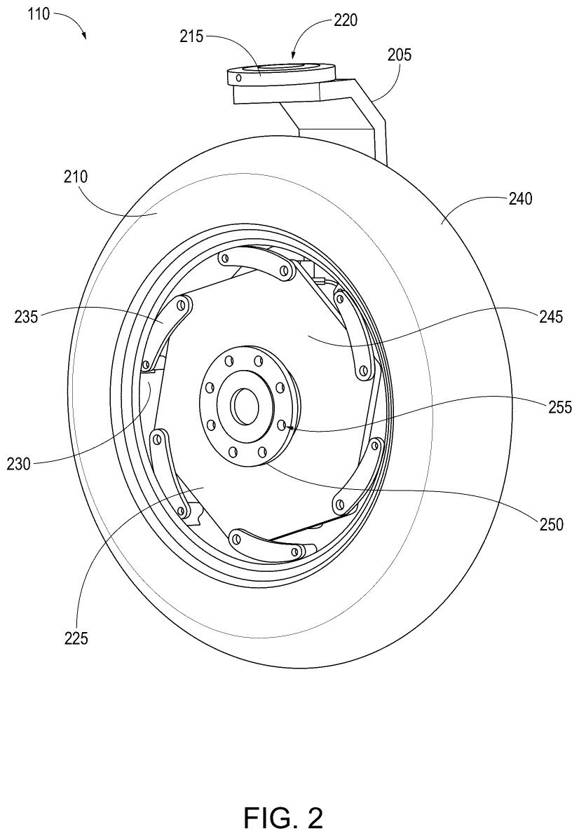

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

Referring to FIG. 1, a system 100 includes a vehicle 105 with one or more wheel assemblies 110 for moving and/or steering the vehicle 105. In one example, the vehicle 105 include an agricultural vehicle or other agricultural equipment, such as tractors, grain carts, irrigation, high clearance sprayers, and tracked plow vehicles, to name just a few examples. The vehicle 105 includes an electrical power supply 115 for supplying electrical power to the vehicle 105 as we well as ancillary equipment. In one variation, the vehicle 105 is a serial type hybrid vehicle that uses an engine, a generator coupled to the engine, and an energy storage system (ESS), like a battery, to form the electrical power supply 115. In another variation, the power supply 115 of the vehicle 105 can include a parallel type hybrid system, and in still yet another example, the vehicle 105 can include a battery electric vehicle (BEV). To facilitate communication between various electronic components within or outside of the vehicle 105, the vehicle 105 includes a communication bus 120. For instance, the communication bus 120 can facilitate communication between various sensors and controllers, such as engine control modules (ECMs), pressure sensors, and the like. In the illustrated example, the power supply 115 is electrically coupled to the wheel assembly 110 so as to provide electrical power to the wheel assembly 110, and the communication bus 120 is communicatively coupled to the wheel assembly 110 so as to facilitate communication between the wheel assembly 110 and the communication bus 120.

Commonly, agricultural vehicles and equipment include an internal combustion engine (ICE) powered hydraulic drive train or an electric powered hydraulic system. Although effective, these hydraulic systems have been found to be usually not very energy efficient, require significant maintenance, and have limitations in precision for controlling the vehicle or equipment. In light of this, there has been a recent trend to develop partially or fully electric mobile power systems for agricultural vehicles 105 and other agricultural equipment. It has been discovered that such electric powertrain systems enhance performance in terms of efficiency, speed, data collection, accuracy, and even yield. Electrical powertrains are usually able to provide more power with higher precision than conventional hydraulic powertrains. Moreover, electrical powertrains are able to react more quickly than hydraulic systems.

Due to the financial risks and other issues associated with farming, some (if not most) farmers prefer to have the ability to repair as well as modify agricultural vehicles and equipment to meet their own particular needs. However, it has been discovered that most electrical powertrain designs are, as a practical matter, difficult or nearly impossible to repair and/or modify. These electrical powertrain designs typically have a centralized controller buried within the vehicle that controls the electric motors of the vehicle. As a result, modifying the logic of and/or function of the controller is a daunting task. The battery packs inside these vehicles also supply dangerously high voltages which makes any repair or other change extremely hazardous. It has been further found that the extensive cabling and other wiring in these centralized electrical powertrain systems can create electrical interference and cause communication issues. Moreover, it has been discovered that due to the complicated layout of the lubrication and cooling systems of the electric motors in these systems makes any repair expensive and difficult. A simple leaking coolant and/or lubrication hose may be difficult to repair or replace such that the entire vehicle may be inoperative. The centralized nature of these design also makes any modification, physically and/or via software, to meet specialize agricultural needs extremely difficult.

As will be explained in greater detail below, the wheel assembly 110 has been generally designed to be a modular or self-contained unit that is independently able to provide precise motive power and control for the vehicle 105. The wheel assembly 110 includes a modular drive unit that can be readily replaced and programmed for various applications. The lubrication, cooling, motive power, control, sensor, and monitoring functions are self-contained within the drive unit of the wheel assembly 110. If there is a maintenance or repair issue, the entire wheel assembly 110 or just the drive unit is swapped out and replaced with a new one. Once replaced, the wheel assembly 110 is then connected to the power supply 115 and the communication bus 120 of the wheel assembly 110. This modular design allows the vehicle 105 to be used with various vehicle powertrain architectures like ICE, hybrid, or BEV type powertrains.

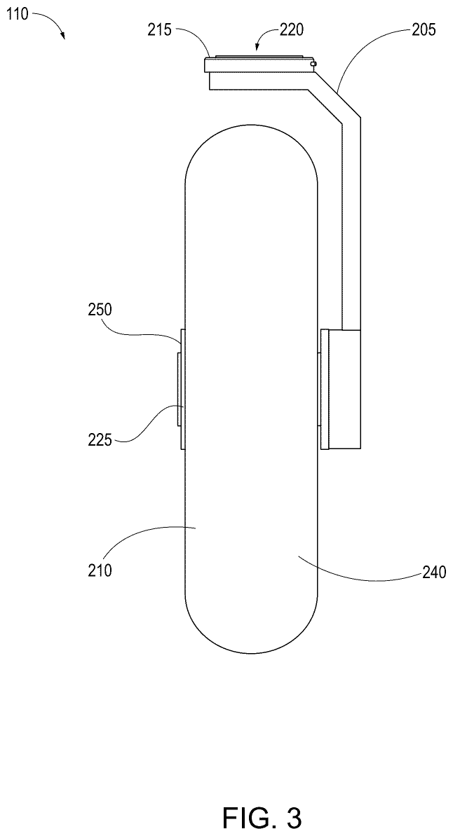

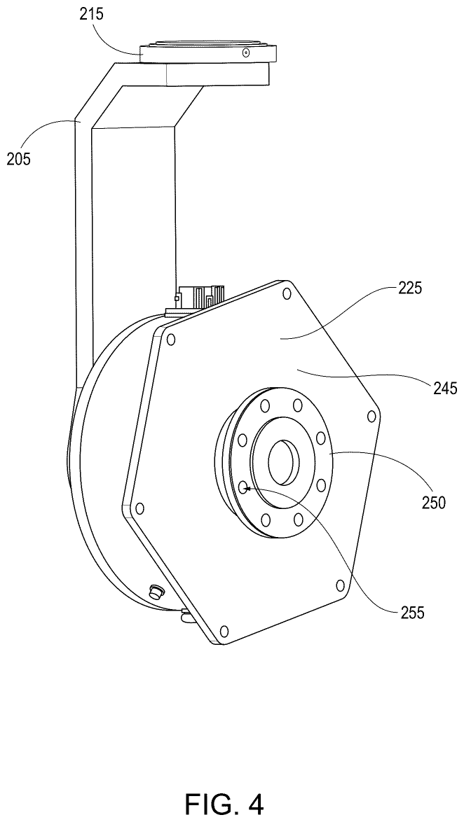

Looking at FIGS. 2, 3, and 4, the wheel assembly 110 includes a bracket 205 configured to mount to the vehicle 105 and a wheel 210 rotatably coupled to the bracket 205. The bracket 205 has a bracket bearing 215 that is sandwiched between the vehicle 105 and the bracket 205 to facilitate turning or steering of the wheel assembly 110. The bracket 205 and the bracket bearing 215 define a conduit opening 220 that facilitates routing of electrical cables and communication wires from the wheel assembly 110 to the power supply 115 and the communication bus 120 of the vehicle 105. In one variation, the communication bus 120 of the vehicle 105 and the wheel assembly 110 are communicatively coupled via a wired connection. In another variation, the communication bus 120 and the wheel assembly 110 are communicatively coupled via a wireless connection.

The wheel 210 includes a hub 225 rotatably coupled to the bracket 205, a rim 230 surrounding the hub 225, one or more spokes 235 connecting the hub 225 to the rim 230, and a tire 240 secured around the rim 230. In the illustrated example, the hub 225 has a load plate 245 and an auxiliary adapter 250 extending from the load plate 245. The auxiliary adapter 250 allows auxiliary agricultural equipment to mechanically connect to the bracket 205 of the wheel assembly 110. The auxiliary adapter 250 defines one or more auxiliary fastener openings 255 configured to receive fasteners, like screws, that secure the auxiliary equipment to the auxiliary adapter 250. Once the auxiliary equipment is secured to the auxiliary adapter 250 via the fasteners, the auxiliary equipment or device is held at a fixed position (e.g., does not rotate).

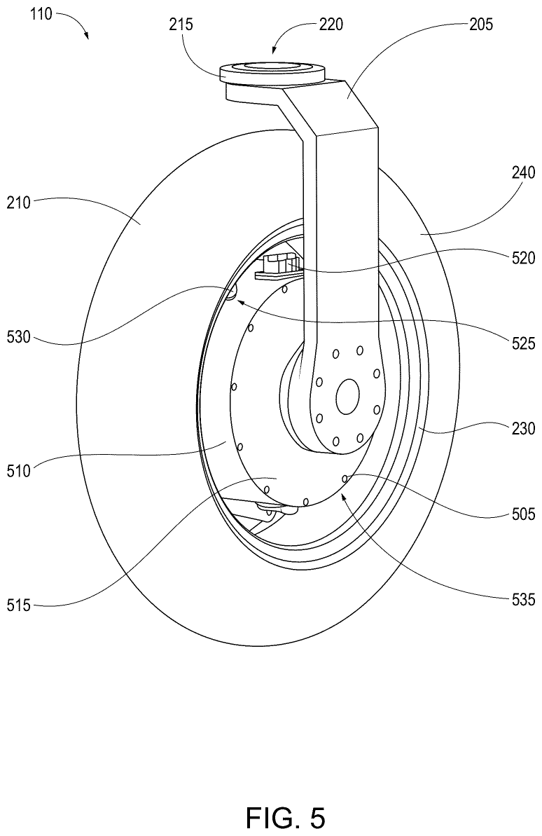

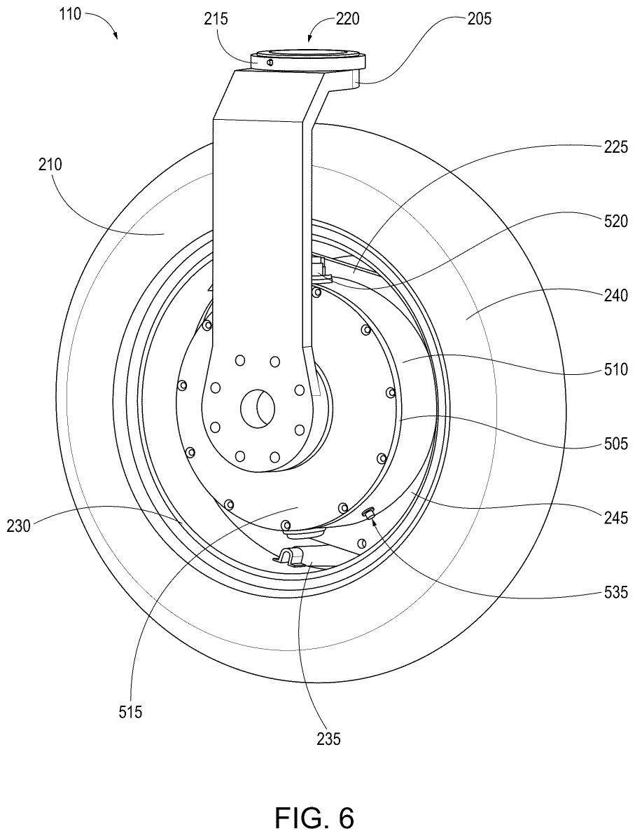

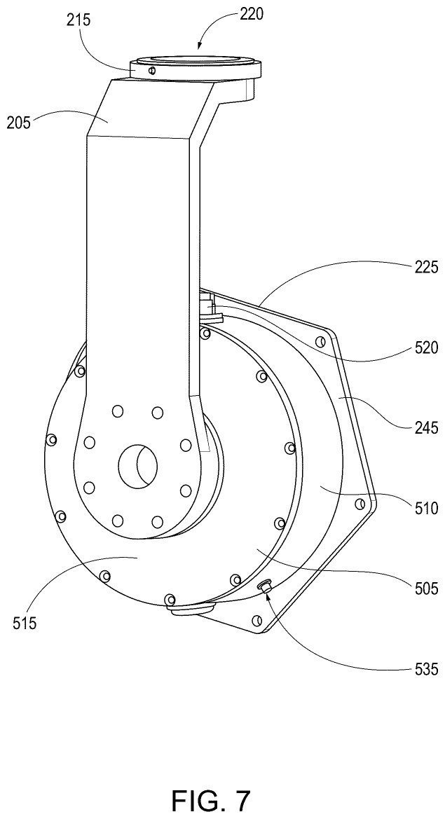

Referring now to FIGS. 5, 6, and 7, the wheel assembly 110 further includes a drive unit 505 operatively coupled between the bracket 205 and the wheel 210. As noted before, the drive unit 505 is a modular component that can be readily programmed, modified, adapted, and repaired. The drive unit 505 is configured to generate mechanical force to rotate the wheel 210 so as to move the vehicle 105. The drive unit 505 has a housing 510 with a cover 515 that stores and protects the various components of the drive unit 505. The drive unit 505 further has a controller socket 520 that is configured to receive and process the electrical power from the power supply 115 of the vehicle 105, and the controller socket 520 facilitates communication with the communication bus 120 of the vehicle 105. As will be explained in greater detail below, the controller socket 520 in some case is further configured to control the operation of the drive unit 505. In one form, the controller socket 520 includes a socket to which the power cables and communication wires from the vehicle 105 are plugged. The housing 510 defines a lubricant opening 525 through which lubricant is supplied to or drained from the drive unit 505, and the lubricant opening 525 is plugged with a plug 530. The drive unit 505 further has an air vent 535 to equalize air pressure inside the drive unit 505 with ambient air pressure outside of the drive unit 505.

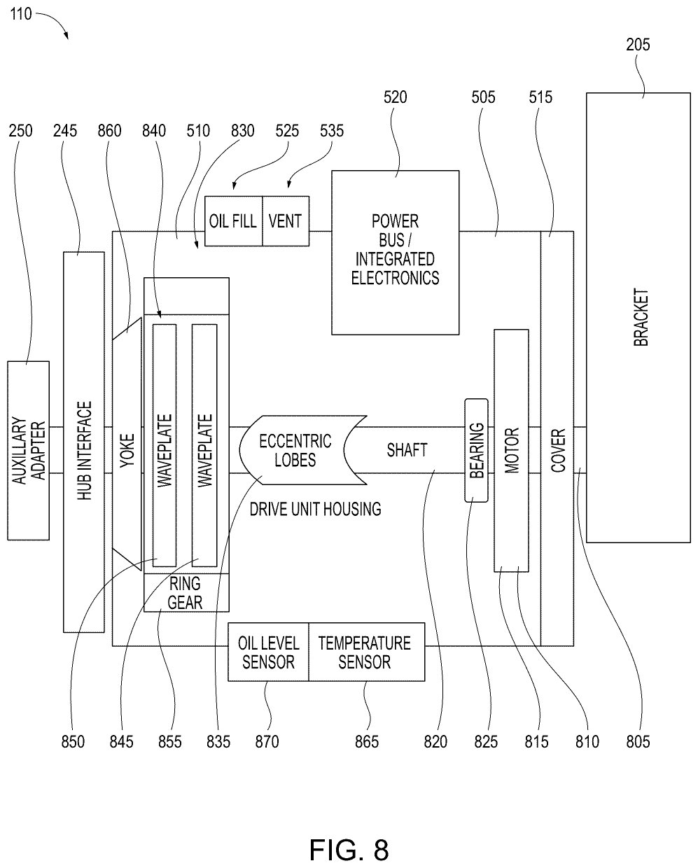

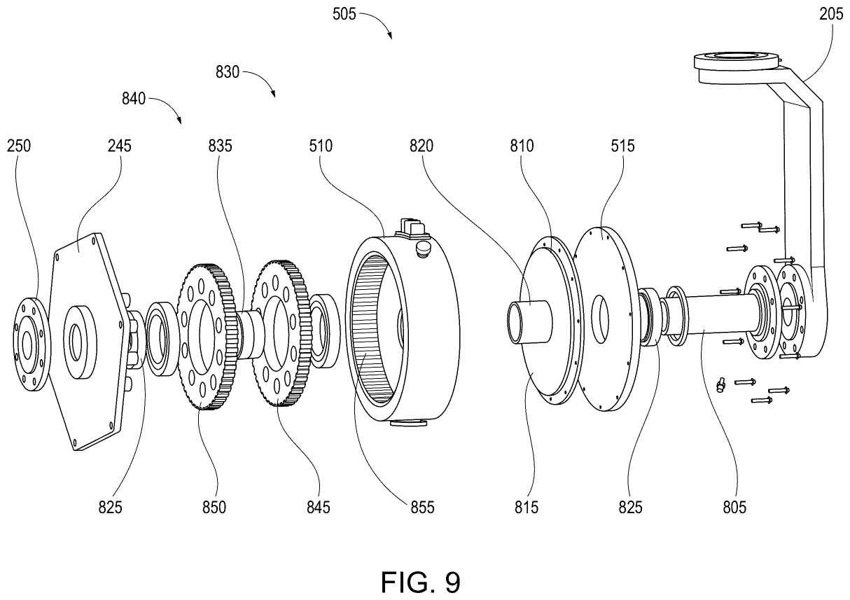

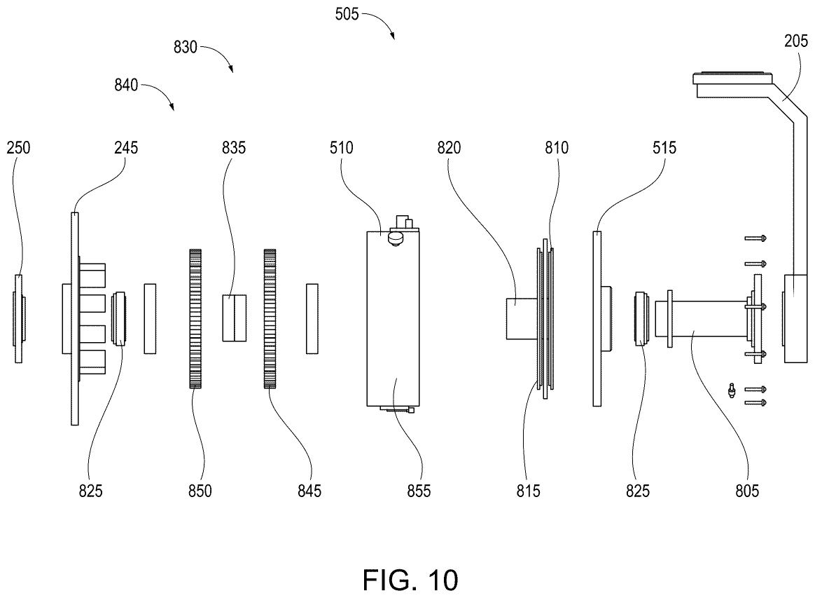

FIG. 8 shows a block diagram of the drive unit 505 along with the bracket 205. FIGS. 9 and 10 respectively illustrate perspective and side exploded views of the drive unit 505 with the bracket 205. As depicted, the bracket 205 has an axle 805 that extends through the drive unit 505. Generally, the wheel 210 as well as components of the drive unit 505 rotate about the axle 805. The axle 805 extends through the cover 515, and opposite to the bracket 205, the end of the axle 805 is secured to the auxiliary adapter 250. The drive unit 505 further includes a motor 810, and in the illustrated example, the motor 810 is an electric motor 815. In one version, the electric motor 815 is an axial flux brushless motor, but the electric motor 815 can include other kinds of electric motors. The motor 810 receives the axle 805, and the electric motor 815 has a shaft 820 that is hollow to receive the axle 805. In one version, the shaft 820 is keyed or otherwise secured to the axle 805 so that the shaft 820 is unable to significantly rotate or otherwise move about the axle 805.

To reduce friction, the drive unit 505 has one or more roller bearings 825 disposed around the axle 805. In the illustrated example, the drive unit 505 has two roller bearings 825 positioned at opposite ends of the axle 805. In other examples, the drive unit 505 can have more or less roller bearings 825 than is shown. The roller bearing 825 positioned proximal to the bracket 205 is disposed between the cover 515 and the axle 805. This roller bearing 825 allows the housing 510 and the cover 515 to rotate relative to the axle 805. The other roller bearing 825 at the opposite end of the axle 805 is disposed between the axle 805 and the load plate 245 to allow the load plate 245 to rotate relative to the fixed axle 805. As will be explained further below, due to the cycloidal action, the load plate 245 and the housing 510 rotate in opposite directions when the electric motor 815 is powered.

Electric motors commonly are designed to operate efficiently at high speeds or rotations per minute (rpms) which is usually acceptable for passenger vehicles. Unlike passenger vehicles, agricultural vehicles and other equipment tend to travel at relatively slow speeds and require high torques to travel over soil. Traditional transmissions usually include planetary gears to reduce the rpms and increase torque. It has been found that these types of transmissions are rather too bulky for agricultural equipment and still do not provide sufficient torque for common farm use cases.

To address these as well as other issues, the drive unit 505 includes a cycloidal gear train 830 that increases the torque supplied by the electric motor 815. The cycloidal gear train 830 in the drive unit 505 includes one or more eccentric lobes 835 engaged to the shaft 820 of the electric motor 815. The eccentric lobes 835 rotate or guide one or more wave plates 840 of the cycloidal gear train 830 in an eccentric manner relative to the rotational axis of the shaft 820 of the electric motor 815. In the illustrated example, the cycloidal gear train 830 includes two wave plates 840, a first wave plate 845 and a second wave plate 850. In other examples, the cycloidal gear train 830 can include more or less wave plates 840 than is shown. The wave plates 840 are received inside and engage a ring gear 855. In the illustrated example, the ring gear 855 is integrated as part of the housing 510 of the drive unit 505. In other examples, the ring gear 855 can be a separate component from the housing 510. The cycloidal gear train 830 has a yoke 860 that engages the wave plates 840. In the illustrated example, the yoke 860 and the load plate 245 are integrated together to form a single unit, but in other examples, the yoke 860 and the load plate 245 can be separate components.

When the electric motor 815 is powered, the housing 510 rotates about the axle 805. With the ring gear 855 of the housing 510 rotating, the wave plates 840 inside the ring gear 855 rotate in an eccentric manner via the eccentric lobes 835 about the shaft 820 and the axle 805. The load plate 245 which is engage with the wave plates 840 in turn rotates. Due to the cycloidal action of the cycloidal gear train 830, the housing 510 and the load plate 245 rotate in opposite directions. As a result of the rotating load plate 245, the wheel 210 rotates.

As noted above, the drive unit 505 is designed to be a stand alone or modular unit that is able to operate independently. The drive unit 505 is designed to maintain proper lubrication and temperatures inside the drive unit 505. The drive unit 505 is configured to control the operation of the motor 810, and the controller socket 520 is configured to monitor the overall health and performance of the drive unit 505. If needed, a controller located inside or connected to the controller socket 520 can take corrective actions or provide appropriate alerts. The lubricant, such as oil, inside the housing 510 of the drive unit 505 is replenished via the lubricant opening 525. The lubricant lubricates and cools the components of the drive unit 505 such as the electric motor 815 and the wave plates 840. Any overheating may degrade the lubricant and/or damage components of the drive unit 505. Likewise, low lubricant or oil levels may damage the drive unit 505. To reduce these risks, the drive unit 505 has a temperature sensor 865 and a lubricant level sensor 870 that are operatively connected to the controller socket 520 so as to provide data concerning the health of the drive unit 505. For instance, the temperature sensor 865 is configured to provide to the controller socket 520 the temperature of the lubricant inside the drive unit 505, and the lubricant level sensor 870 is able to provide to the controller socket 520 the level or volume of lubricant inside the housing 510 of the drive unit 505.

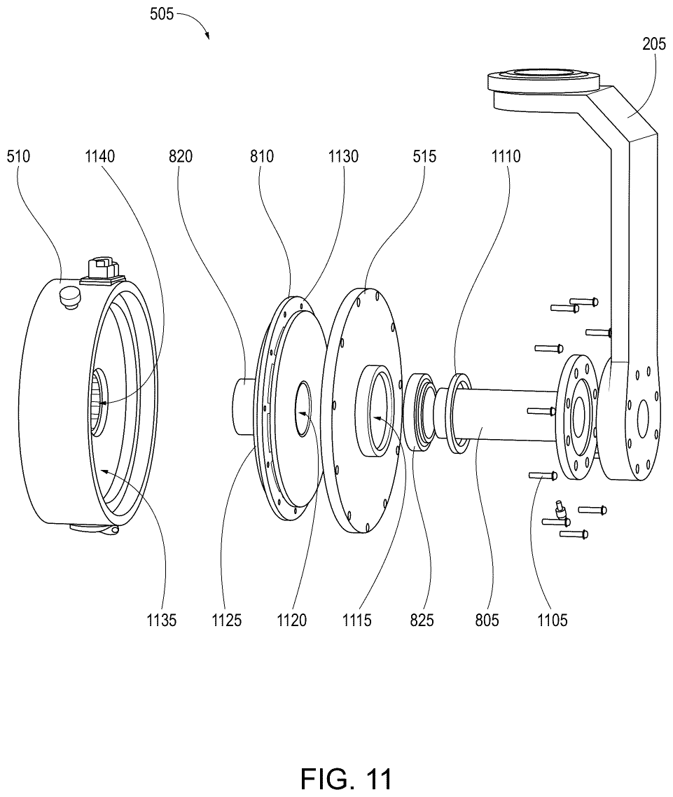

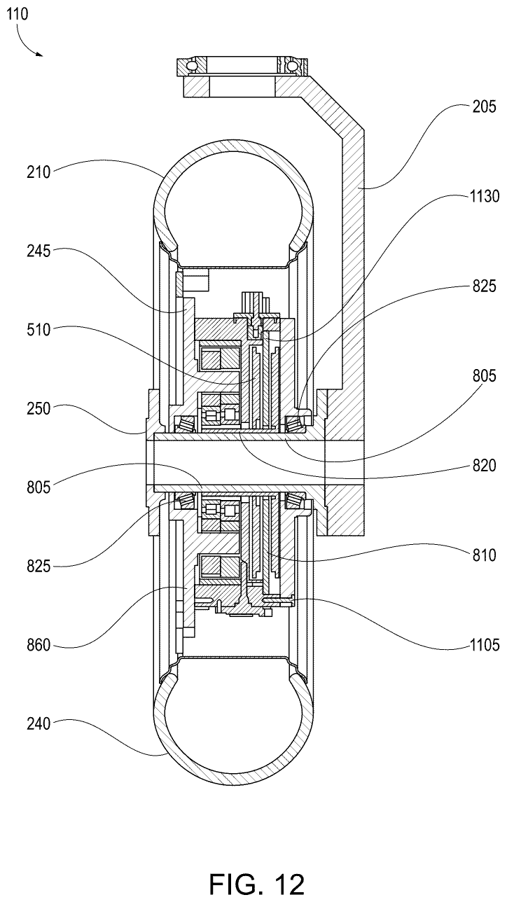

FIG. 11 shows an exploded view of the drive unit 505 around the motor 810, and FIG. 12 shows a cross-sectional view of the wheel assembly 110. In the illustrated example, the axle 805 is secured to the bracket 205 via one or more fasteners 1105, but the axle 805 can be secured to the bracket 205 in other manners. For instance, the axle 805 in other examples is integrally formed with the bracket 205. Around the axle 805, the drive unit 505 has a gasket 1110 that seals between the axle 805 and the cover 515 so as to minimize leakage of the lubricant from the drive unit 505. As shown, the roller bearing 825 is received around the axle 805. The cover 515 defines a cover opening 1115 through which the axle 805 extends through the cover 515.

The motor 810 defines an axle opening 1120 through which the axle 805 extends. The axle opening 1120 in the motor 810 extends through the shaft 820 that is hollow. The axle 805 extends through the axle opening 1120 in the shaft 820 of the motor 810 such that the axle 805 and the axle opening 1120 are arranged in a concentric manner. The motor 810 includes a rotor 1125 which is secured to the shaft 820 and a stator 1130 which is secured to the cover 515 of the housing 510 via the fasteners 1105. In the depicted example, the rotor 1125 is in the form of two plates disposed on opposing sides of the stator 1130 such that the stator 1130 is sandwiched between the plates of the rotor 1125. It should be recognized that the rotor 1125 and the stator 1130 can be structured differently in other examples.

The housing 510 defines a motor cavity 1135 with a shaft opening 1140. Once the drive unit 505 is assembled, the motor 810 is received in the motor cavity 1135, and the shaft 820 of the motor 810 along with the axle 805 extends through the shaft opening 1140. Via the fasteners 1105, the cover 515 is secured to the housing 510 so as to enclose the motor 810 within the motor cavity 1135 of the housing 510. It should be recognized that the cover 515 can be secured to the housing 510 in other manners such as via welding, adhesives, and the like. After assembly, the stator 1130 is stationary relative to the housing 510 and the cover 515. Once more, the shaft 820 is keyed or fixed to the axle 805. The rotor 1125 along with the shaft 820 remain stationary relative to the axle 805. As noted before, when the motor 810 is energized, the stator 1130, which is fixed to the housing 510, causes the housing 510 to rotate about the axle 805.

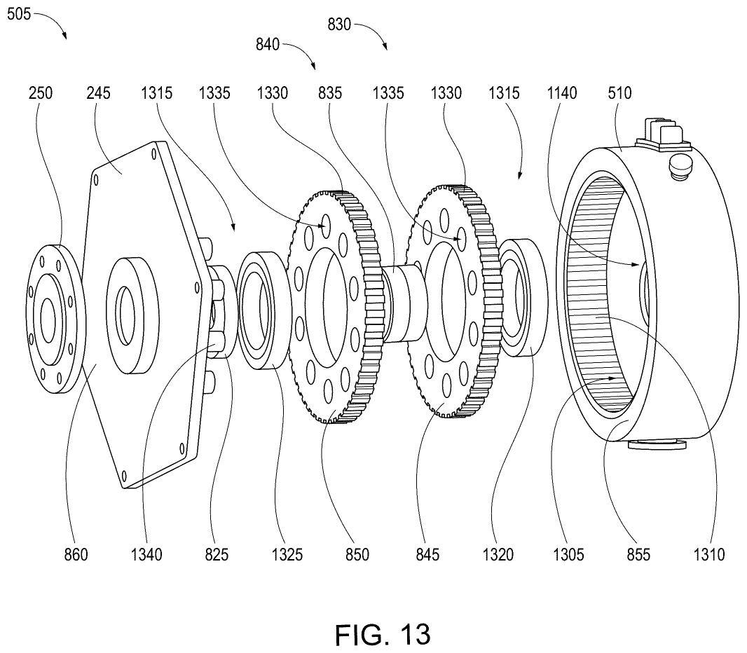

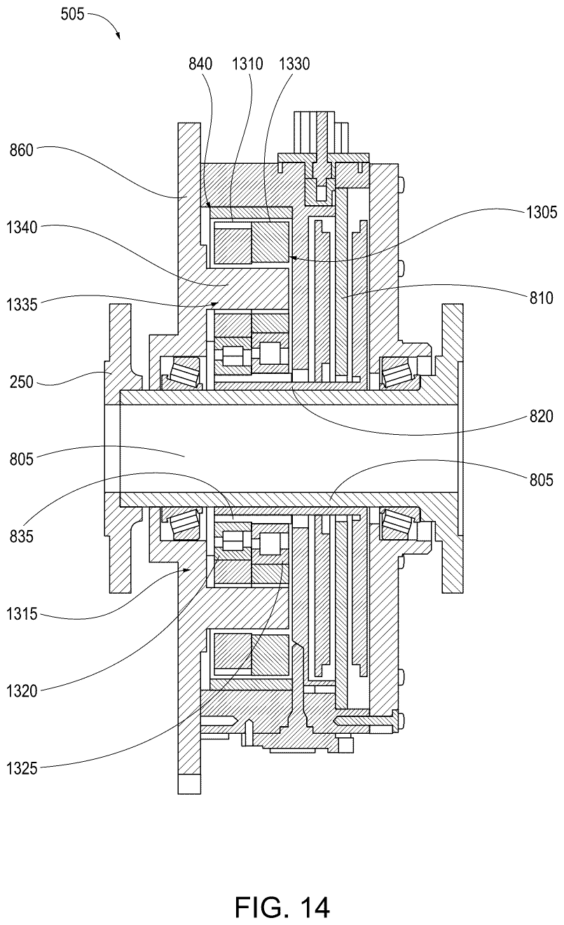

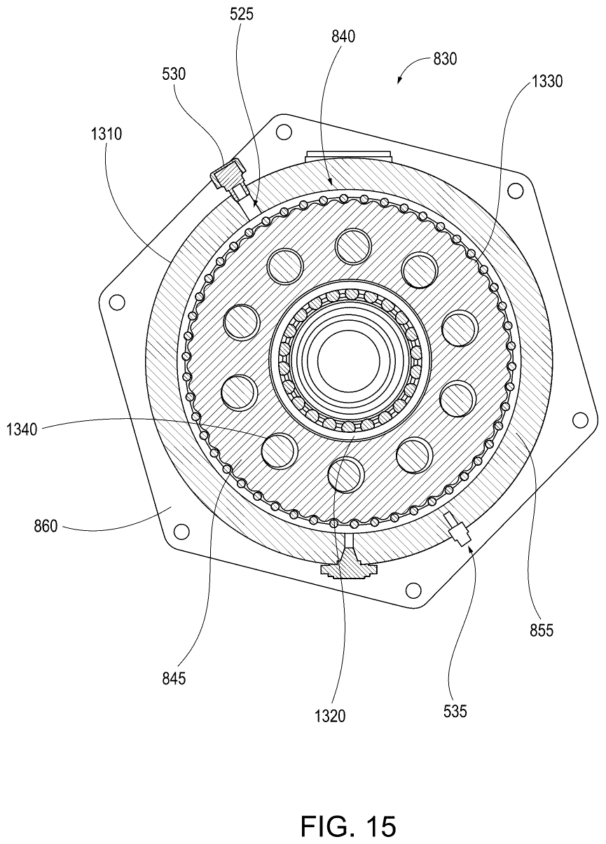

FIG. 13 shows an exploded view of the cycloidal gear train 830 in the drive unit 505, and FIG. 14 shows a side cross-sectional view of the drive unit 505. FIG. 15 depicts a cross-sectional view of the cycloidal gear train 830. As shown, the ring gear 855 in the housing 510 defines a gear cavity 1305 where the wave plates 840 are housed. Around the periphery of the gear cavity 1305, the ring gear 855 has a series of ring gear teeth 1310 where the wave plates 840 engage the ring gear 855. The cycloidal gear train 830 further includes one or more eccentric bearings 1315 that are received around the eccentric lobes 835, and the eccentric lobes 835 are secured to the shaft 820. The eccentric bearings 1315 are received inside the wave plates 840. When the motor 810 rotates the housing 510, the eccentric lobes 835 causes the wave plates 840 to move or rotate in an eccentric matter relative to the rotational axis defined by the axle 805. In the illustrated example, the cycloidal gear train 830 includes two wave plates 840, but in other examples, the cycloidal gear train 830 can include a single wave plate 840 or more than two wave plates 840. The eccentric bearings 1315 include a first eccentric bearing 1320 that is received in the first wave plate 845 and a second eccentric bearing 1325 that is received in the second wave plate 850. The eccentric lobes 835 are shaped so that the wave plates 840 are eccentrically offset from one another.

Each of the wave plates 840 has wave plate gear teeth 1330 that engage the ring gear teeth 1310 of the ring gear 855 and one or more pin openings 1335 that engage with the yoke 860. In one version of the cycloidal gear train 830, the ring gear teeth 1310 are in the form of lobes having a hypocycloid curved shape, and the wave plate gear teeth 1330 of the wave plates 840 are in the form of epicyclodial lobes designed to smoothly engage with the hypocycloidal recess defined between the ring gear teeth 1310 of the ring gear 855. The ring gear teeth 1310 and the wave plate gear teeth 1330 can be shaped differently in other examples. For instance, in some other variations, the shapes of the ring gear teeth 1310 and the wave plate gear teeth 1330 can be reversed. The yoke 860 has one or more pins 1340 that extend inside the pin openings 1335 of the wave plates 840 so as to engage the yoke 860 with the wave plates 840. As the motor 810 rotates the housing 510, which in turn rotates the wave plates 840 in an eccentric manner, the pins 1340 cause the yoke 860 to rotate about the axle 805. This rotary motion of the yoke 860 in turn causes the wheel 210 to rotate. As noted before, due to the cycloidal gear train 830, the housing 510 and the yoke 860 rotate in opposite directions when the electric motor 815 operates.

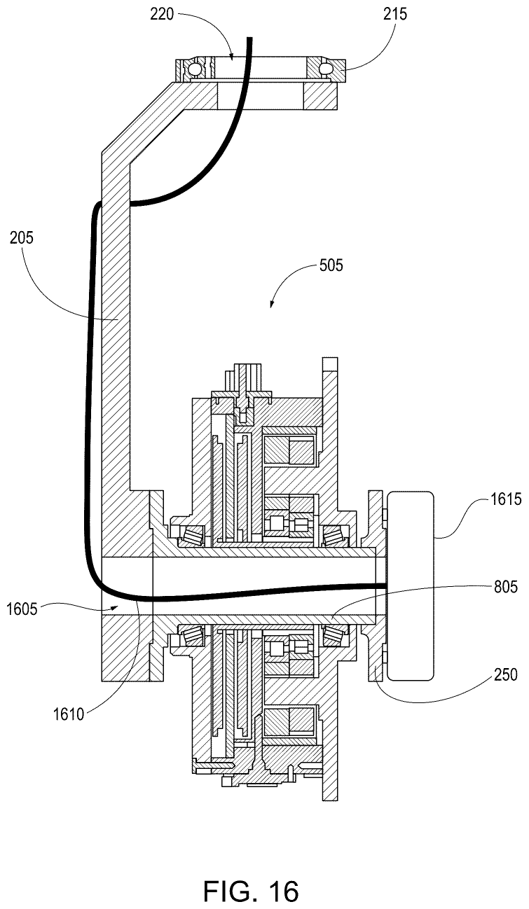

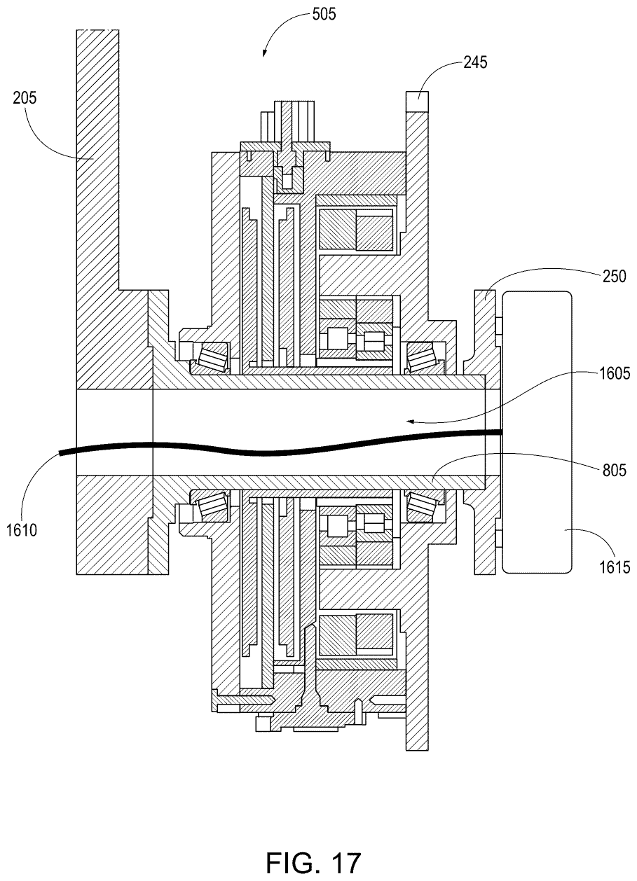

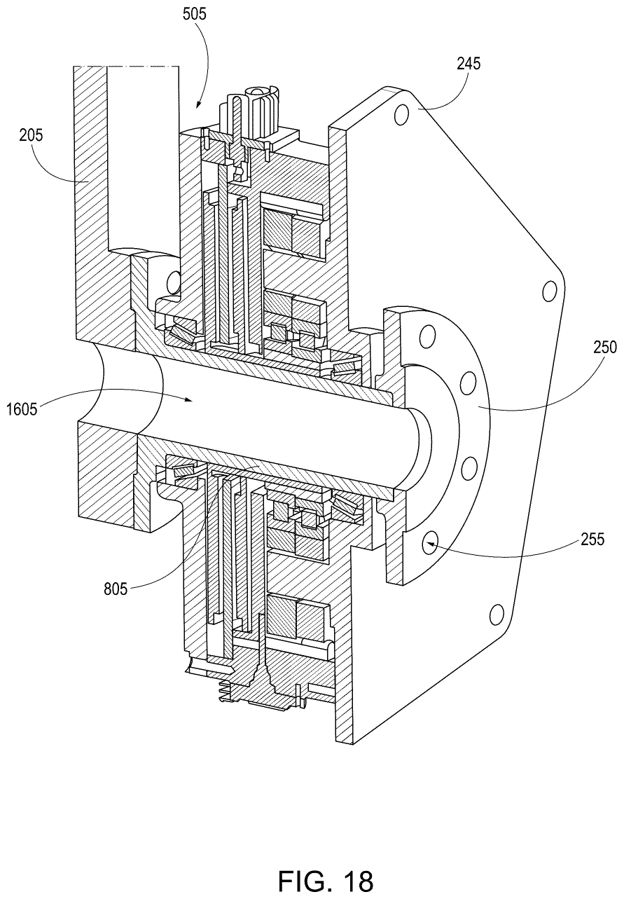

Turning to FIGS. 16, 17, and 18, the bracket 205 and the bracket bearing 215 define the conduit opening 220 so as to provide access to the drive unit 505. The axle 805 in the illustrated example is hollow. As shown, the bracket 205, the auxiliary adapter 250, and the axle 805 define a passage 1605 through the drive unit 505. In the depicted example, a cable 1610 is routed through the wheel 210 and the passage 1605. The passage 1605 can be for instance operatively coupled to the power supply 115 and/or the communication bus 120 of the vehicle 105. At the auxiliary adapter 250, the cable 1610 is connected to an auxiliary device 1615 such as a light, transponder, electronic device, or other type of device. Looking at FIG. 18, the auxiliary device 1615 is secured to the auxiliary adapter 250 via the auxiliary fastener openings 255. This ability to route cables 1610, wires, and the like can also facilitate establish an electrical power and/or communication connection between the vehicle 105 and the drive unit 505.

In another example, the auxiliary device 1615 is another drive unit 505 that is mechanically connected to the auxiliary adapter 250. Multiple drive units 505 can be mechanically and/or electronically daisy chained together to coordinate operation of the drive units 505. The axle 805 of the added drive unit 505 is secured to the auxiliary adapter 250. The cable 1610 is then routed through the passage 1605 defined in both drive units 505 so as to electrically and/or communicatively connect the drive units 505 together.

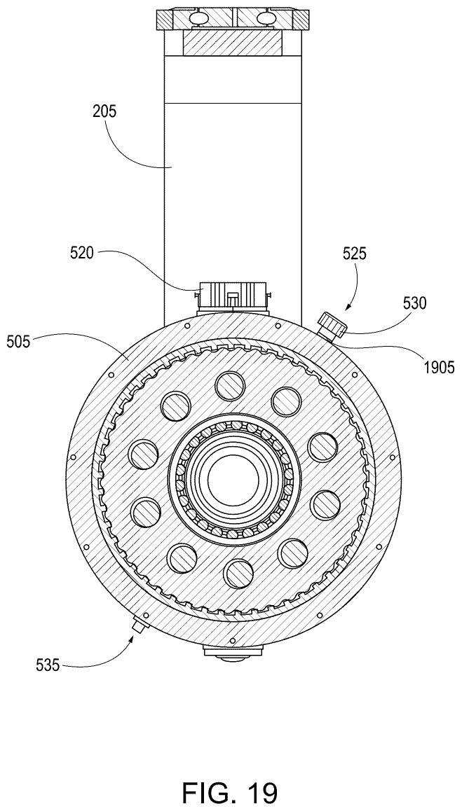

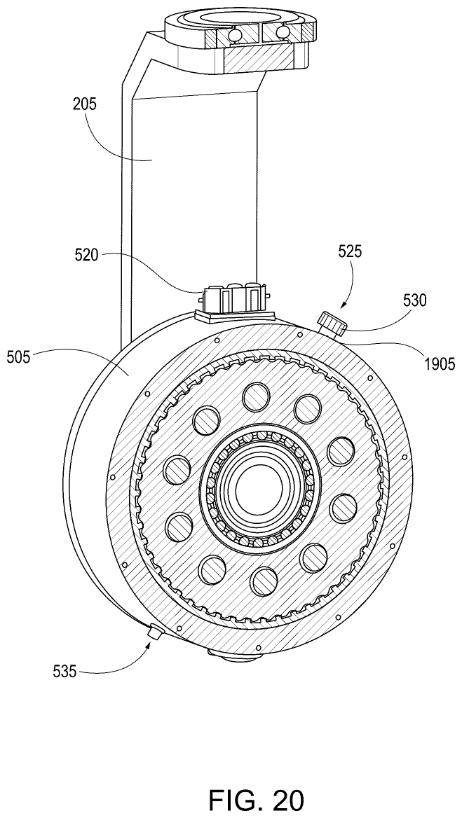

FIGS. 19 and 20 show the relative locations of the controller socket 520, the lubricant opening 525 with the plug 530, and the air vent 535 on the drive unit 505. The lubricant opening 525 and the air vent 535 are disposed on opposite sides of the drive unit 505 to facilitate lubricant drainage during an oil change. For instance, the drive unit 505 can be rotated to face in a downwards direction, and the plug 530 can be remove from the lubricant opening 525 during drainage. At the same time, the air vent 535, which faces in an upwards direction, is opened to allow air to enter the drive unit 505 so as to facilitate drainage of the lubricant. To fill the drive unit 505 with lubricant, the lubricant opening 525 is rotated to face in an generally upwards direction, and the air vent 535 is closed.

Ferrous or other magnetic materials, like iron or steel, may wear or grind off the wave plates 840 or other components of the drive unit 505. The resulting metal shavings or particulates may be suspended in the lubricant. If not removed, the suspended particulates may cause premature wear and other damage to components in the drive unit 505. To address this, the plug 530 has a magnet 1905 that extends inside the motor cavity 1135 and/or the gear cavity 1305 of the drive unit 505. The magnetic or ferrous shavings are attracted to the magnet 1905 on the plug 530. When the plug 530 is unplugged from the drive unit 505, the metal shavings on the magnet 1905 can be discarded.

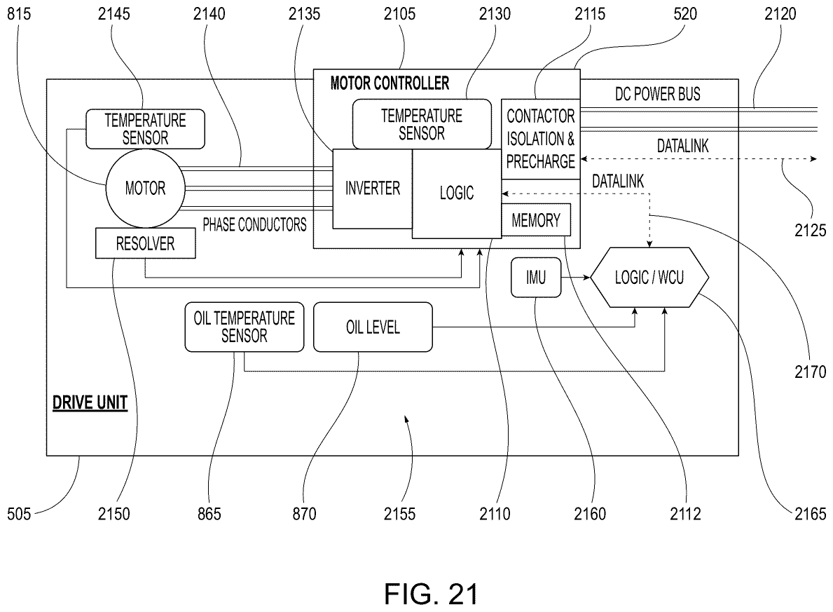

FIG. 21 shows a block diagram of one variation for the controller socket 520 used in the drive unit 505. The controller socket 520 includes a controller 2105 that is configured to control the operation of the electric motor 815 and monitor the state of the drive unit 505. In one version, the controller 2105 is located inside the housing 510 of the drive unit 505, and in another version, the controller 2105 is mounted to the exterior of the housing 510. The controller 2105 includes a processor 2110 that processes information in the controller 2105 as well as controls and monitors the drive unit 505. The controller 2105 has memory 2112 operatively coupled to the processor 2110 where the processor 2110 stores data such as software, sensor data, log data, and the like. The controller socket 520 further includes a connector 2115 where a power bus 2120 from the power supply 115 of the vehicle 105 supplies electrical power to the electric motor 815, the controller 2105, and other components of the drive unit 505. The connector 2115 is further connected to an external data link 2125 that is operatively connected to the communication bus 120 of the vehicle 105. With the external data link 2125 connected to the connector 2115, the controller 2105 is able to communicate with various devices within the vehicle 105. The connector 2115 is equipped with isolation components and/or circuitry that in some cases includes an external or internal pre-charge circuit. This design enhances the operational safety, efficiency, and reliability of the drive unit 505. The controller 2105 has a controller temperature sensor 2130 to monitor the temperature of the controller 2105 as well as other components in the drive unit 505.

To condition and supply the electrical power from the power bus 2120 to the electric motor 815, the controller 2105 has an inverter 2135. The inverter 2135 of the controller 2105 is electrically connected to the electric motor 815 via one or more phase conductors or power cables 2140. In the illustrated example, the electric motor 815 is a three-phase type motor such that the drive unit 505 has three power cables 2140, but in other examples, the drive unit 505 can have more or less power cables 2140 depending on the design of the electric motor 815. As shown, the drive unit 505 has a motor temperature sensor 2145 to monitor the temperature of the electric motor 815 and a resolver 2150 to monitor the position, velocity, acceleration, and/or rotational direction of the electric motor 815. The motor temperature sensor 2145 and the resolver 2150 are operatively connected to the controller 2105 so that the processor 2110 is able to monitor the state or health of the electric motor 815. With the information from the motor temperature sensor 2145 and the resolver 2150, the processor 2110 of the controller 2105 is able to control the electric motor 815, and if needed, the processor 2110 is able to take the appropriate corrective action. For example, if the motor temperature sensor 2145 senses the electric motor 815 becoming too hot, the controller 2105 is able to shutdown the motor. As another example, the processor 2110 of the controller 2105 is able to control the velocity of the wheel 210 and the torque applied by the drive unit 505 to the wheel 210.

The drive unit 505 in some cases has other sensors 2155 to monitor various conditions within or even outside of the drive unit 505. In the illustrated example, the sensors 2155 include the temperature sensor 865, the lubricant level sensor 870, and an inertial measurement unit (IMU) 2160. Once more, the temperature sensor 865 and the lubricant level sensor 870 respectively monitor the level and temperature of the lubricant in the drive unit 505. Among other things, the IMU 2160 is configured to monitor the relative position, velocity, and/or acceleration of the drive unit 505. The temperature sensor 865, the lubricant level sensor 870, and the IMU 2160 are operatively coupled to a sensor hub 2165 in the drive unit 505. The sensor hub 2165 is in turn operatively coupled to the processor 2110 of the controller 2105 via an internal data link 2170. With the data from these sensors 2155, the processor 2110 of the controller 2105 is able to control and monitor the health of the drive unit 505. For instance, the controller 2105 is able to monitor the state of the lubricant in the drive unit 505, and if needed, the controller 2105 is able to take a corrective action (e.g., stop the electric motor 815) and/or provide an alert to the vehicle 105 via the external data link 2125. Through the IMU 2160, the controller 2105 is able to receive feedback concerning the operation of the drive unit 505. For instance, the processor 2110 is able to compare the relative speed of the drive unit 505 and the vehicle 105 to a predicted speed based on the velocity of the electric motor 815 from the resolver 2150. If there is a speed difference outside of specified limits, the controller 2105 can take corrective actions such as by slowing down or speeding up the electric motor 815. Any of this operational data can be stored in the memory 2112 for later retrieval.

The controller 2105, seamlessly integrated within the architecture of the drive unit 505, is calibrated to enhance the application of motive force, promoting operational efficiency, and torque maximization as per the exigencies of the deployment of the drive unit 505. This integration can manifest either as an internal component within the housing 510 of the drive unit 505 or as an externally mounted entity, tethered to the drive unit 505 through phase or power cables 2140. The placement of the controller 2105, which takes into account the minimization of copper losses, helps to preserve operational efficiency of the drive unit 505.

Incorporated within the design of the controller 2105 is a sophisticated logic circuit, like the processor 2110, alongside the inverter 2135. The inverter 2135 is adept in accommodating multiple voltage inputs. These voltage inputs are selected based on the operational demands, and the capability of the internal components of the motor 810. Furthermore, the controller 2105 is equipped with an isolation component or circuitry that is complemented by either an external or internal pre-charge circuit. This design enhances the operational safety, efficiency, and reliability of the drive unit 505.

The inclusion of temperature, current, voltage, torque, rpm, position, and sensing mechanisms within the controller 2105 ensures real-time monitoring and management of thermal conditions, safeguarding against thermal malfunction. Additionally, the controller 2105 is designed to support various duty cycles, which can be effectively managed through either air and/or liquid cooling systems 100. This helps to ensure adaptability of the drive unit 505 to diverse operational environments and cooling requirements.

The drive unit 505 is equipped with a comprehensive array of mounting provisions, designed to facilitate the attachment of external sensors 2155, brackets, and various auxiliary components. These mounting provisions are engineered to enable the connection of steerable linkages that enhance the adaptability of the drive unit 505 to different operational requirements. Alternatively or additionally, the system 100 incorporates specific features for the integration of suspension components, further broadening the scope of application of the drive unit 505. The drive unit 505 also offers the capability to connect with additional drivetrain elements, underscoring the versatility of the drive unit 505 in a wide range of mechanical configurations.

Certain mounting provisions within the drive unit 505 are tailored for specialized application functions, reflecting a bespoke approach to meet the nuanced demands of specific operational contexts. Conversely, a subset of these mounting features is intentionally designed with a generic interface, granting end users the flexibility to adapt and utilize these features according to their unique requirements. This dual approach in the design of mounting features ensures that the drive unit 505 can be seamlessly integrated into a diverse array of mechanical systems, catering both to specific engineering solutions and to broader, more versatile applications.

In some cases, but not all, cases, the drive unit 505 serves a dual purpose. The drive unit 505 is load-bearing, and the drive unit 505 functions as the hub 225 for the wheel 210, incorporating the load-bearing roller bearings 825 to support the weight of the vehicle 105 or other machinery. The roller bearings 825 are designed to be serviced or replaced independently of the eccentric bearings 1315 in the cycloidal gear train 830 or bearings for the motor 810. The roller bearings 825 are specifically rated to withstand the significant motive forces encountered by machinery used in heavy construction, agricultural vehicles, and other severe-duty off-road applications. This design ensures the drive unit 505 can reliably handle the demands of heavy-duty machinery. This design further provides a robust solution for the challenging environments faced by, but not limited to, construction and agricultural equipment.

In most instances, the drive unit 505 should be cooled. Cooling of the drive unit 505 can be done via liquid cooling, air cooling, and/or refrigerant cooling. In some cases, the motor 810 and the cycloidal gear train 830 share a lubricant, such as oil, as the main coolant. In other cases, the oil is cooled separately from the coolant in the motor 810. Liquid to liquid, liquid to air, or air to air heat exchanger methods may be used to cool the coolant.

The drive unit 505 in some variations is equipped with external connection features, such as the auxiliary adapter 250, enabling attachment of the drive unit 505 to various hubs through either direct bolting or a linkage bracket system. This flexibility in mounting options makes the drive unit 505 compatible with rims of different diameters, width, and other geometries. Linkages can be connected to the drive unit 505 and then secured to the hubs 225 of various sizes. As a result, the drive unit 505 can be adapted for use on a wide range of machinery. This versatility enhances the applicability of the drive unit 505 across different equipment types.

The cycloidal gear train 830 is designed with a host of features that ensures that the lubricant reaches all or most of the parts in the drive unit 505. Alternatively or additionally, a magnet is installed within the cycloidal gear train 830 to attract and collect ferrous materials. These materials may originate from external contamination or from the wear and tear of ferrous components of the drive unit 505. This mechanism helps in maintaining the cleanliness and efficiency of the cycloidal gear train 830. The magnet also helps to prevent potential damage caused by metallic debris. As noted before, the drive unit 505 in the system 100 may have the air vent 535 to equalize pressure inside the drive unit 505 with ambient air pressure.

As noted before, the controller 2105 via the sensors 2155 in the drive unit 505 is able to perform lubricant or oil health tracking. For instance, the controller 2105 is able to monitor oil level and oil temperature via the temperature sensor 865 and the lubricant level sensor 870. The processor 2110 in the controller 2105 is also able to monitor winding temperatures in the electric motor 815 via the motor temperature sensor 2145 and the speed of the electric motor 815 through the resolver 2150. The controller 2105 is further able to perform health monitoring of the drive unit 505 via sensors 2155 in the gear cavity 1305 and the motor cavity 1135. The controller 2105 is further able to track time and loads in the drive unit 505.

Having an integrated design, the drive unit 505 is further able to help with maintenance and determine maintenance intervals. With the collected data, the controller 2105 is able to calculate oil life, coolant life, and/or bearing life. The controller 2105 with this data is further able to detect potential failure modes.

The drive unit 505 is equipped with sophisticated sensor subsystems designed to meticulously monitor various aspects of the operation of the drive unit 505, leveraging data collected incrementally over time or through a real-time clock to ensure comprehensive tracking of the health of the drive unit 505. For instance, the controller 2105 via data stored in the memory 2112 is able to detect changes in speed, temperature, and load over time, enabling the controller 2105 to predict with precision when preventive maintenance is needed to avoid potential failures. Moreover, by utilizing these sensor-equipped subsystems, the controller 2105 is able to analyze trends and identify when any component of the drive unit 505 deviates from specified operational parameters. Such trends, including a noticeable increase in the overall temperature of the windings in the electric motor 815 or the lubricant, can be early indicators of potential issues that might compromise the integrity of the drive unit 505. This information, when analyzed in conjunction with data concerning the current of the electric motor 815 and various other parameters managed by the controller 2105, equips technicians with a detailed and predictive overview of the condition of the drive unit 505 and the expected operational lifespan of the drive unit 505. To enhance the depth of mechanical analysis, the addition of gyroscopes and accelerometers, such as in the IMU 2160, allows for a more nuanced examination of changes in mechanical frequencies over time, offering a richer, more detailed map of the performance of the drive unit 505 and potential maintenance needs.

A filter for the lubricant in some cases may also be used. The lubricant in some cases is dispersed via pressurized or gravitational type circulation techniques. As the electric motor 815 heats up, positive pressure tends to build up within the drive unit 505. A similar phenomenon can occur due to the change of altitude or due to barometric pressure changes from weather. Pressure increase can occur when the drive unit 505 is outside and baked in the sun or even during routine operation. In some cases, preheating of the lubricant system via the cooling unit is performed. The air vent 535 may be used to handle the differences of pressure. In one form, the air vent 535 utilizes a GOR-TEX® brand (W.L Gore and Associates, Inc.) type material or similar vent material to prevent corrosive gas, dirt, larger debris, or chemicals from entering and contaminating the drive unit 505. The air vent 535 is further configured to prevent moisture intrusion. In the case of an overfilled drive unit 505, the air vent 535 is designed to relieve the resulting high pressures.

The axle 805 in the drive unit 505 may be solid or hollow. When the shaft 820 is hollow, cables 1610, lubricant and/or coolant may be internally routed to the drive unit 505. The hollow axle 805 further allows the cable 1610 to be routed between multiple drive units 505. The cables 1610, lubricant, and/or coolant may be routed internally and externally to the drive unit 505. In some cases, the axle 805 has an eccentric shape.

The drive unit 505 is a versatile component capable of powering a wide range of drive trains, serving as either the primary or secondary source of propulsion for the vehicle 105. The applications for the drive unit 505 extend across wheeled, tracked, and legged equipment, offering similar capabilities as highlighted above, including (but not limited to) reduced axial length, high positional accuracy, high efficiency, and superior torque transference. For instance, the rim 230 typically employed in the wheel 210 or a tracked vehicle 105 can also function as the joint of a legged machine or alternatively act as an actuator. Furthermore, when applied to trailers, the drive unit 505 can efficiently operate as either the main or auxiliary motive force, showcasing the adaptability and utility in various vehicular configurations.

With the cycloidal gear train 830, high reductions may be achieved of at least 10:1 via a single stage. In some cases, multiple gear reduction stages may be used. There are different methods of achieving the high reduction ratio. One method for achieving high reduction is via the cycloidal gear train 830. Another reduction method may be achieved via a combination of the cycloidal gear train 830 and another type of gear train such as a planetary gear train. In another variation, a rotary vector (RV) reducer or RV cycloidal gearbox is used to achieve gear ratios of 50:1 up to 100:1, and in some cases, the RV reducer is capable of achieving a 1000:1 gear ratio. Generally speaking, single stage cycloidal gears can provide higher efficiency than other gearbox technologies.

The wave plates 840 in some versions are made from corrosion-resistant steel to ensure the longevity of the cycloidal gear train 830 in the drive unit 505. To further prevent corrosion, lubrication is employed. Alternatively or additionally, the edges of the wave plates 840 are case-hardened to withstand high torque forces. The increased hardness of the edges reduces wear of the wave plates 840. This wear reduction created by case hardening of the wave plates 840 is further enhanced via the lubrication subsystem within the drive unit 505, which reduces friction between surfaces of the wave plates 840 that are under high stress.

The drive unit 505 is versatile enough to function as the driving force behind a variety of non-vehicular devices, facilitating operations such as but not limited to winching, slewing, and the articulation of manipulator joints. The drive unit 505 is adept at enabling the precise movement of large implements, showcasing utility of the drive unit 505 in a broad spectrum of applications beyond traditional vehicular use. This adaptability makes the drive unit 505 a desirable component for tasks requiring controlled, fine-tuned motion so as to extend the applicability of the drive unit 505 to industries and scenarios where precision and reliability are required.

The drive unit 505 in some forms includes electrical bonding provisions. For example, the drive unit 505 in some versions includes one or more bonding points or bonding straps. These bonding points or bonding straps ground the drive unit 505 to help bond the drive unit 505 to the rest of the vehicle 105.

In some variations, the drive units 505 includes provisions for interacting with the tire 240. The drive unit 505 in one form is configured to increase or decrease air pressure in the tire 240 to enhance traction of the tire 240. In another example, the drive unit 505 circulates cooling fluid for cooling the electric motor 815 and/or the cycloidal gear train 830 within the tire 240.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Asymmetric” or “Asymmetrical” generally refers to a property of something having two sides or halves that are different from one another, such as in shape, size, and/or style. In other words, asymmetric describes something lacking a mirror-image quality.

“Bearing” generally refers to a machine element that constrains relative motion and reduces friction between moving parts to only the desired motion, such as a rotational movement. The bearing for example can be in the form of loose ball bearings found in a cup and cone style hub. The bearing can also be in the form of a cartridge bearing where ball bearings are contained in a cartridge that is shaped like a hollow cylinder where the inner surface rotates with respect to the outer surface by the use of ball or other types of bearings.

“Cable” generally refers to one or more elongated strands of material that may be used to carry electromagnetic or electrical energy. A metallic or other electrically conductive material may be used to carry electric current. In another example, strands of glass, acrylic, or other substantially transparent material may be included in a cable for carrying light such as in a fiber-optic cable. A cable may include connectors at each end of the elongated strands for connecting to other cables to provide additional length. A cable is generally synonymous with a node in an electrical circuit and provides connectivity between elements in a circuit but does not include circuit elements. Any voltage drop across a cable is therefore a function of the overall resistance of the material used. A cable may include a sheath or layer surrounding the cable with electrically non-conductive material to electrically insulate the cable from inadvertently electrically connecting with other conductive material adjacent the cable. A cable may include multiple individual component cables, wires, or strands, each with, or without, a non-conductive sheathing. A cable may also include a non-conductive sheath or layer around the conductive material, as well as one or more layers of conductive shielding material around the non-conductive sheath to capture stray electromagnetic energy that may be transmitted by electromagnet signals traveling along the conductive material of the cable, and to insulate the cable from stray electromagnetic energy that may be present in the environment the cable is passing through. Examples of cables include twisted pair cable, coaxial cable, “twin-lead”, fiber-optic cable, hybrid optical and electrical cable, ribbon cables with multiple side-by-side wires, and the like.

“Cavity” generally refers to an empty space in a solid object. The cavity can be completely or partially surrounded by the solid object. For example, the cavity can be opened to the surrounding environment.

“Controller” generally refers to a device, using mechanical, hydraulic, pneumatic electronic techniques, and/or a microprocessor or computer, which monitors and physically alters the operating conditions of a given dynamical system. In one non-limiting example, the controller can include an Allen Bradley brand Programmable Logic Controller (PLC). A controller may include a processor for performing calculations to process input or output. A controller may include a memory for storing values to be processed by the processor, or for storing the results of previous processing. A controller may also be configured to accept input and output from a wide array of input and output devices for receiving or sending values. Such devices include other computers, keyboards, mice, visual displays, printers, industrial equipment, and systems or machinery of all types and sizes. For example, a controller can control a network or network interface to perform various network communications upon request. The network interface may be part of the controller or characterized as separate and remote from the controller. A controller may be a single, physical, computing device such as a desktop computer, or a laptop computer, or may be composed of multiple devices of the same type such as a group of servers operating as one device in a networked cluster, or a heterogeneous combination of different computing devices operating as one controller and linked together by a communication network. The communication network connected to the controller may also be connected to a wider network such as the Internet. Thus, a controller may include one or more physical processors or other computing devices or circuitry and may also include any suitable type of memory. A controller may also be a virtual computing platform having an unknown or fluctuating number of physical processors and memories or memory devices. A controller may thus be physically located in one geographical location or physically spread across several widely scattered locations with multiple processors linked together by a communication network to operate as a single controller. Multiple controllers or computing devices may be configured to communicate with one another or with other devices over wired or wireless communication links to form a network. Network communications may pass through various controllers operating as network appliances such as switches, routers, firewalls or other network devices or interfaces before passing over other larger computer networks such as the Internet. Communications can also be passed over the network as wireless data transmissions carried over electromagnetic waves through transmission lines or free space. Such communications include using Wi-Fi or other Wireless Local Area Network (WLAN) or a cellular transmitter/receiver to transfer data.

“Cycloidal Gear Train” generally refers to a gear system that uses at least one cycloidal rotor or wave plate to transfer motion and power. The wave plate has lobes with a cycloid shape that engage a ring gear or a series of pins surrounding the rotor. When engaging the ring gear or pins, the wave plate moves in an eccentric path to convert an input rotation into a reduced output rotation. Cycloid gear trains typically provide high torque densities, minimal backlash, and high efficiency.

“Eccentric” generally refers to having an axis located elsewhere than at the geometric center of an object or relative an axis of another object. As one non-limiting example, when oriented in an eccentric manner, the object has an axis of revolution displaced from the center of the object (or relative to another object) so that the object is capable of imparting reciprocating motion. In other words, something is considered eccentric when it is not placed centrally or does not have its axis or other part placed centrally.

“Electric Motor” generally refers to an electrical machine that converts electrical energy into mechanical energy. Normally, but not always, electric motors operate through the interaction between one or more magnetic fields in the motor and winding currents to generate force in the form of rotation. Electric motors can be powered by direct current (DC) sources, such as from batteries, motor vehicles, and/or rectifiers, or by alternating current (AC) sources, such as a power grid, inverters, and/or electrical generators. An electric generator can (but not always) be mechanically identical to an electric motor, but operates in the reverse direction, accepting mechanical energy and converting the mechanical energy into electrical energy.

“Electrical Connection” generally refers to a connection between two objects that allows a flow of electric current and/or electric signals.

“Energy Storage System” (ESS) or “Energy Storage Unit” generally refers to a device that captures energy produced at one time for use at a later time. The energy can be supplied to the ESS in one or more forms, for example including radiation, chemical, gravitational potential, electrical potential, electricity, elevated temperature, latent heat, and kinetic types of energy. The ESS converts the energy from forms that are difficult to store to more conveniently and/or economically storable forms. By way of non-limiting examples, techniques for accumulating the energy in the ESS can include: mechanical capturing techniques, such as compressed air storage, flywheels, gravitational potential energy devices, springs, and hydraulic accumulators; electrical and/or electromagnetic capturing techniques, such as using capacitors, super capacitors, and superconducting magnetic energy storage coils; biological techniques, such as using glycogen, biofuel, and starch storage mediums; electrochemical capturing techniques, such as using flow batteries, rechargeable batteries, and ultra batteries; thermal capture techniques, such as using eutectic systems, molten salt storage, phase-change materials, and steam accumulators; and/or chemical capture techniques, such as using hydrated salts, hydrogen, and hydrogen peroxide. Common ESS examples include lithium-ion batteries and super capacitors.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Gear Train” generally refers to a system of gears that transmit power from one mechanical component to another. The gear train provides controlled application of mechanical power. The gear train uses gears to provide speed and/or torque conversions from a rotating power source to another device. For example, a gear train can include a combination of two or more gears, mounted on rotating shafts, to transmit torque and/or power. As one non-limiting example, the gear train for instance can include a planetary gearset and/or a cycloidal gearset.

“Housing” generally refers to a component that covers, protects, and/or supports another thing. A housing can have a unitary construction or be made of multiple components. The housing can be made from the same material or a combination of different materials. The housing can include a protective cover designed to contain and/or support one or more mechanical components. Some non-limiting examples of a housing include a case, enclosure, covering, body, and shell.

“Inertial Measurement Unit” or “IMU” generally refers to a device that measures and reports a body's specific force, angular rate, and sometimes the magnetic field surrounding the body. The IMU typically, but not always, includes one or more accelerometers and gyroscopes, and sometimes magnetometers when the surrounding magnetic fields are measured. IMUs are typically (but not always) self-contained systems that measure linear and angular motion usually with a triad of gyroscopes and triad of accelerometers. An IMU can either be gimballed or strapdown, outputting the integrating quantities of angular velocity and acceleration in the sensor/body frame. They are commonly referred to in literature as the rate-integrating gyroscopes and accelerometers. IMUs typically can be used in a wide variety of circumstances such as to maneuver vehicles, aircraft, and/or spacecraft as well as in cellphones and virtual reality glasses. The accelerometers in IMUs can include mechanical and/or electronic type accelerometers, and the gyroscopes in IMUs can include mechanical and/or electronic type gyroscopes.

“Inverter” or “Power Inverter” generally refers to an electronic device and/or circuitry that at least converts direct current (DC) to alternating current (AC). Certain types of inverters can further include a rectifier that converts AC to DC such that the inverter and rectifier functions are combined together to form a single unit that is sometimes referred to as an inverter. The inverter can be entirely electronic or may be a combination of mechanical devices, like a rotary apparatus, and electronic circuitry. The inverter can further include static type inverters that do not use moving parts to convert DC to AC.

“Lateral” generally refers to being situated on, directed toward, or coming from the side.

“Longitudinal” generally refers to the length or lengthwise dimension of an object, rather than across.

“Lubricant” generally refers to a substance that is used to reduce friction between the surfaces of rotating or moving objects. For example, a lubricant may be an oil or grease that is used to reduce friction between ball bearings, interlocking gears, and/or other rotating parts in a motor or engine. In addition to reducing friction, lubricants may be used for other purposes. For example, lubricants may cool surfaces, transport particles, transmit forces, and/or perform other functions.

“Magnet” generally refers to a material or object that produces a magnetic field external to itself. Types of magnets include permanent magnets and electromagnets. By way of non-limiting examples, magnets in certain circumstances are able to attract (or repel) objects such as those made of iron or steel.

“Memory” generally refers to any storage system or device configured to retain data or information. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, an electric motor, a hydraulic motor, a steam engine, a pneumatic piston, a hydraulic piston, and/or an internal combustion engine.

“Opening” generally refers to a space or hole that something can pass through.

“Power Supply” or “Power Source” generally refers to an electrical device that provides electrical power to an electrical load, such as electrical machines and/or electronics.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement. The concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, and the unknown number may automatically change over time as well. The concept of a “processor” includes a device configured or programmed to make threshold comparisons, rules comparisons, calculations, or perform logical operations applying a rule to data yielding a logical result (e.g., “true” or “false”). Processing activities may occur in multiple single processors on separate servers, on multiple processors in a single server with separate processors, or on multiple processors physically remote from one another in separate computing devices.

“Resolver” generally refers to a type of rotary sensor for measuring the degree of rotation, velocity, and/or acceleration of a rotary type device. In one example, the resolver includes a rotary electrical transformer used for measuring degrees of rotation such as in an electric motor, an electric generator, and/or a transmission. The resolver can include analog or digital type electrical devices. The resolver can be in the form of a two-pole type resolver or a multi-pole type resolver. Some other types of resolvers include receiver type resolvers and differential type resolvers.

“Rotor” generally refers to a part or portion in a machine that rotates in or around a stationary part, which is commonly referred to as a stator. The rotor is the moving or rotating part of a rotary system, such as found in electric generators, electric motors, sirens, mud motors, turbines, and/or biological rotors. In one particular non-limiting example, the rotor includes the rotating portion of an electric generator and/or motor, especially of an induction motor.

“Sensor” generally refers to an object whose purpose is to detect events and/or changes in the environment of the sensor, and then provide a corresponding output. Sensors include transducers that provide various types of output, such as electrical and/or optical signals. By way of nonlimiting examples, the sensors can include pressure sensors, ultrasonic sensors, humidity sensors, gas sensors, motion sensors, acceleration sensors, displacement sensors, force sensors, optical sensors, and/or electromagnetic sensors. In some examples, the sensors include barcode readers, RFID readers, and/or vision systems.

“Stator” generally refers to a stationary part or portion in a machine in or about which a rotating part revolves, which is commonly referred to as a rotor. The stator is the stationary part of a rotary system, such as found in electric generators, electric motors, sirens, mud motors, turbines, and/or biological rotors. In one particular non-limiting example, the stator includes the stationary portion of an electric generator and/or motor, especially of an induction motor.

“Temperature Sensor” or “Thermometer” generally refers to a device or instrument that measures temperature or a temperature gradient. The thermometer can include empirical or absolute type thermometers as well as primary or secondary based thermometers. Some non-limiting examples of thermometers include thermometers using thermal expansion, pressure, density, optical, electrical resistance, electrical potential, and/or electrical resonance techniques for measuring temperature.

“Tire” generally refers to a toroidal or doughnut-shaped component of a wheel that encircles a rim of the wheel. The tire is configured to transfer the load of a vehicle to the ground or other driving surface and provide traction between the vehicle and the driving surface. Tires can be complex structures made from a variety of materials such as rubber, steel, and/or fabric. Some common types of tires include pneumatic, solid, semi-pneumatic, and foam-filled tires, to name just a few examples.

“Tire Pressure” generally refers to the force exerted by a compressed air or other gas within a pneumatic tire, measured as a function of force per unit area. Tire pressure is typically expressed in units of pounds per square inch (psi) in the United States, or kilopascals (kPa) using the metric system. Tire pressure is usually measured as gauge pressure, which is the pressure relative to atmospheric pressure. In contrast, absolute pressure is the total pressure, including atmospheric pressure. Pneumatic tires typically rely on pressurized air or other gas to maintain the shape of the tire and support load. The tire pressure can be increased by adding air or other gas to increases the number of air or gas molecules inside the tire, and conversely, tire pressure can be reduced by removing the air or other gas from the tires so as to reduce the number of air or gas molecules in the tire. Tire pressure may be for example impacted by temperature, load, and altitude. Tire pressure directly affects the ability of the tire to support weight. Underinflation reduces load capacity, and overinflation increases load capacity but can lead to other issues. The tire pressure also influences the stiffness of the tire, which affects handling, ride comfort, and rolling resistance. Proper tire pressure can be used to adjust the contact patch between the tire and the driving surface so as to enhance tire grip and stability.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 vehicle
110 wheel assembly
115 power supply
120 communication bus
205 bracket
210 wheel
215 bracket bearing
220 conduit opening
225 hub
230 rim
235 spokes
240 tire
245 load plate
250 auxiliary adapter
255 auxiliary fastener openings
505 drive unit
510 housing
515 cover
520 controller socket
525 lubricant opening
530 plug
535 air vent
805 axle
810 motor
815 electric motor
820 shaft
825 roller bearings
830 cycloidal gear train
835 eccentric lobes
840 wave plates
845 first wave plate
850 second wave plate
855 ring gear
860 yoke
865 temperature sensor
870 lubricant level sensor
1105 fasteners
1110 gasket
1115 cover opening
1120 axle opening
1125 rotor
1130 stator
1135 motor cavity
1140 shaft opening
1305 gear cavity
1310 ring gear teeth
1315 eccentric bearings
1320 first eccentric bearing
1325 second eccentric bearing
1330 wave plate gear teeth
1335 pin openings
1340 pins
1605 passage
1610 cable
1615 auxiliary device
1905 magnet
2105 controller
2110 processor
2112 memory
2115 connector
2120 power bus
2125 external data link
2130 controller temperature sensor
2135 inverter
2140 power cables
2145 motor temperature sensor
2150 resolver
2155 sensors
2160 IMU
2165 sensor hub
2170 internal data link

What is claimed is:

1. A system, comprising:
a drive unit including
an electric motor,
a cycloidal gear train coupled to the electric motor, and
a controller operatively coupled to the electric motor to control the electric motor.

2. The system of claim 1, further comprising:
a sensor disposed in the drive unit to monitor at least one property of the drive unit; and
wherein the sensor is operatively coupled to the controller.

3. The system of claim 2, wherein the controller is configured to monitor health of the drive unit via the sensor.

4. The system of claim 2, wherein the sensor includes a temperature sensor.

5. The system of claim 4, wherein the temperature sensor is configured to measure temperature of lubricant in the drive unit.

6. The system of claim 4, wherein the temperature sensor is configured to measure temperature of the electric motor.

7. The system of claim 4, wherein the temperature sensor is configured to measure temperature of the controller.

8. The system of claim 2, wherein the sensor includes a resolver configured to monitor the electric motor.

9. The system of claim 2, wherein the sensor includes an inertial measurement unit (IMU).

10. The system of claim 2, wherein:
the drive unit has the housing; and
the housing contains a lubricant.

11. The system of claim 10, wherein the sensor is a lubricant level sensor that measures a level of the lubricant in the housing.

12. The system of claim 10, wherein:
the lubricant is configured to cool the electric motor; and
the lubricant is configured to lubricate the cycloidal gear train.

13. The system of claim 10, further comprising:
a magnet disposed in the housing to collect ferrous materials.

14. The system of claim 10, further comprising:
a socket extending through the housing;
wherein the socket is configured to connect to an external communication bus; and
wherein the socket is configured to connect to an external power supply to supply electrical power to the drive unit.

15. The system of claim 1, further comprising:
an inverter electrically connected to the electric motor; and
the inverter is disposed inside the drive unit.

16. The system of claim 1, wherein:
the drive unit has an auxiliary adapter; and
the auxiliary adapter is configured to secure an auxiliary device to the drive unit.

17. The system of claim 16, wherein the auxiliary device includes a second drive unit.

18. The system of claim 16, further comprising:
an axle extending through the drive unit;
wherein the axle is hollow; and
wherein the axle and the auxiliary adapter define a passage through the drive unit.

19. The system of claim 1, wherein:
the drive unit has a housing;
the cycloidal gear train includes a ring gear and one or more wave plates engaged in the ring gear;
the ring gear is integrated in the housing;
the cycloidal gear train includes a yolk engaged to the wave plates;
the yolk is integrated in a load plate;
the load plate is configured to drive a wheel of a vehicle; and
the housing and the load plate are configured to rotate in opposite directions when the motor rotates the housing.

20. A method, comprising:
driving a cycloidal gear train of a drive unit with an electric motor;
monitoring with a processor one or more properties of the drive unit via one or more sensors; and
controlling operation of the electric motor with the processor based on the properties of the drive unit.
